(19) United States
(12) Patent Application Publication
(10) Pub. No.: US 2004/0229019 A1
(43) Pub. Date: Nov. 18, 2004

(54) Molded foldable engine cover

(76) Inventors: Jeffrey A. Tilton, Prospect, KY (US); Stephen A. Schutte, Columbus, OH (US); Paul W. Poole, Huntersville, NC (US); Eric S. Walsh, Joeltown, TN (US); Felton Canady, Cleveland, TN (US); Kevin M. Herreman, Heath, OH (US)

Correspondence Address: OWENS CORNING, 2790 COLUMBUS ROAD, GRANVILLE, OH, 43023, US

(21) Appl. No.: 10/440,282

(22) Filed: May 16, 2003

(51) Int. Cl. B32B 3/00

(52) U.S. Cl. 428/172

(57) ABSTRACT

An insulating element includes a sheet of polymer based blanket material having multiple panels and at least one hinge for interconnecting the multiple panels. A method for making such an insulating product includes the forming of a sheet of polymer based blanket material with multiple panels and at least one hinge for interconnecting the multiple panels and erecting the sheet of polymer based blanket material into a three dimensional insulating product by folding the sheet about the hinge.

### TECHNICAL FIELD AND INDUSTRIAL APPLICABILITY OF THE INVENTION

The present invention relates generally to acoustical and thermal insulators and, more particularly, to an insulating element, a method of making an insulating element and a method of insulating a consumer product whereby a two dimensional insulating element is made into a three dimensional consumer product.

### BACKGROUND OF THE INVENTION

It is well known in the art to provide acoustical and thermal insulators on an automobile, truck or other vehicle in an effort to protect and insulate the operating or passenger compartment from the noise and heat generated by the mechanical equipment of the associated vehicle. Toward this end, mats of high temperature glass fibers have been utilized, e.g. (a) on the firewall between the dashboard and engine compartment and (b) along the floor pan of the vehicle between the passenger compartment and the drive line and exhaust system. Liners are also provided in the doors, the ceiling and along other components of the vehicle.

Insulators are also commonly employed in other environments including but not limited to the housings of kitchen appliances such as ovens, dishwashers and refrigerators, other home appliances, such as clothes washers and dryers, as well as on building panels and office partitions and the like. For many applications the insulators are molded to a desired three dimensional shape so that they will nest with the particular component or provide a cavity of a desired shape so as to encompass and accommodate a component to be held in the insulator. Such insulators have been formed in the past by molding with three dimensional tools. Such three dimensional tools are relatively expensive to make and often must be replaced when one or more parts of the consumer product are redesigned or other even minor design modifications are made. Each component of the three dimensional tooling represents a significant capital expense that must either be passed along to the consumer or absorbed by the manufacturer.

The present invention addresses this problem by providing an insulating element and methods whereby relatively inexpensive two dimensional tooling is utilized to make three dimensional insulator products.

### SUMMARY OF THE INVENTION

In accordance with the purposes of the present invention as described herein, an insulating element is provided. The insulating element comprises a sheet of polymer based blanket material including multiple panels and at least one hinge for interconnecting the multiple panels.

Further describing the invention, the insulating element includes a seam between the multiple panels and means for sealing the seam. That means may, for example, take the form of adhesive or tape. Where tape is used a portion of the tape is folded over an edge of the sheet.

The polymer based blanket material may be selected from a group of materials consisting of polyolefin, polyester, polypropylene, polyethylene, fiberglass, acrylic, natural fibers, nylon, rayon and blends thereof. In one possible embodiment the polymer based blanket material is selected from a group consisting of (a) thermoplastic polyester staple fibers and thermoplastic bicomponent fibers, (b) glass staple fibers and thermoplastic bicomponent fibers and (c) mixtures thereof.

The insulating element may further include a facing layer constructed from a material selected from a group consisting of polyester, rayon, metallic foil and any mixtures thereof.

In another possible embodiment the polymer based blanket material includes polyester staple fibers and polyester bicomponent fibers. The polyester staple fibers and polyester bicomponent fibers have diameters of between about 8.0 to about 30.0 microns and lengths between about 1.25 and about 8.0 cm. The polymer based blanket material may also include melt blown microfibers. Further, the insulating element may take the form of an engine cover insulator or substantially any other appropriate product for which insulators of the type described may be utilized.

In accordance with another aspect of the present invention, a method of making a three dimensional insulating product is provided. That method includes the steps of forming a sheet of polymer based blanket material with multiple panels and at least one hinge for interconnecting the multiple panels and erecting the sheet of polymer based blanket materials into the insulating product by folding the sheet about the at least one hinge.

The method may be further described as including the step of sealing a seam formed between the multiple panels following folding of the sheet. This may be done by adhering or taping the panels together and closing the seam.

The method of making an insulating product may also be described as comprising the steps of cutting a blank of polymer based blanket material, forming the blank into a product sheet including multiple panels and at least one hinge for interconnecting the panels and folding the multiple panels about the at least one hinge to provide a three dimensional insulating product. Further the method includes using two dimensional tools in the forming process.

In accordance with yet another aspect of the present invention a method of insulating a consumer product is provided. That method includes the cutting of a blank of polymer based blanket material, the forming of the blank into a product sheet including multiple panels and at least one hinge for interconnecting the panels and the folding of the panels about the at least one hinge to provide a three dimensional insulating product while fitting the insulating product to the consumer product. The method further includes sealing a seam formed between the multiple panels during folding. This can include taping a seam formed between the multiple panels during that folding process.

In accordance with still another aspect of the present invention the method of insulating a consumer product may include the steps of cutting a blank of polymer based blanket material, forming the blank into a product sheet including multiple panels and at least one hinge for interconnecting the panels and folding the multiple panels about the at least one hinge to provide a three dimensional insulating product while fitting the insulating product to a fixture corresponding to a desired size and shape. The method further includes the sealing of a seam formed between the multiple panels during folding. This may be done by taping the seam. Further, the method includes clipping the product sheet to the fixture to hold the sheet in place prior to taping.

The following description shows and describes several embodiments of this invention simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWING

The accompanying drawing incorporated in and forming a part of this specification, illustrates several aspects of the present invention, and together with the description serves to explain certain principles of the invention. In the drawing:

FIG. 1 is a top plan view showing one possible insulating element of the present invention;

FIGS. 2a and 2b are schematical cross sectional views of the insulating element shown in FIG. 1 illustrating alternative layer constructions;

FIG. 3 is a perspective view of the three dimensional insulating product constructed from the two dimensional insulating element shown in FIG. 1;

FIG. 4 illustrates how the two dimensional sheet is folded and fitted into a fixture and a seam between panels is pinned closed for taping; and

FIG. 5 is a top plan view of another alternative embodiment of an insulating element of the present invention.

Reference will now be made in detail to the present preferred embodiment of the invention, examples of which are illustrated in the accompanying drawing.

### DETAILED DESCRIPTION OF THE INVENTION

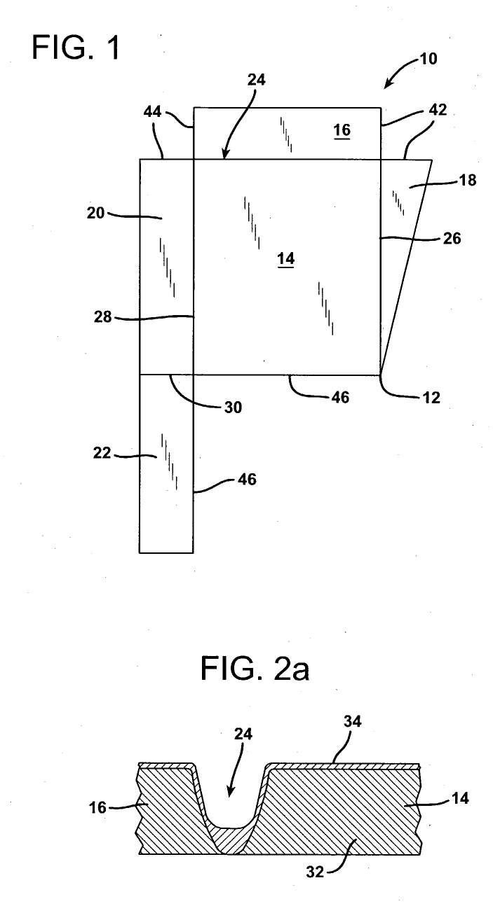

Reference is now made to FIG. 1 illustrating the insulating element 10 of the present invention. As illustrated that insulating element 10 comprises a sheet 12 of polymer based blanket material. The sheet 12 includes a first panel 14, a second panel 16, a third panel 18, a fourth panel 20 and the fifth panel 22. A first hinge 24 interconnects the first and second panels 14, 16. A second hinge 26 interconnects the first panel 14 with the third panel 18. A third hinge 28 interconnects the first panel 14 with the fourth panel 20 while a fourth hinge 30 interconnects the fourth panel 20 with the fifth panel 22.

The polymer based blanket material may be selected from a group of materials consisting of polyolefin, polyester, polypropylene, polyethylene, fiberglass, acrylic, natural fibers, nylon, rayon and blends thereof. In one possible embodiment the polymer based blanket material is selected from a group consisting of (a) thermoplastic polyester staple fibers and thermoplastic bicomponent fibers, (b) glass staple fibers and thermoplastic bicomponent fibers and (c) mixtures thereof.

In one particular embodiment, the polymer based blanket material includes polyester staple fibers and polyester bicomponent fibers. Those fibers have diameters of between about 8.0 to about 30.0 microns and lengths of between about 1.25 and about 8.0 cm. The polymer based blanket material may or may not include melt blown microfibers.

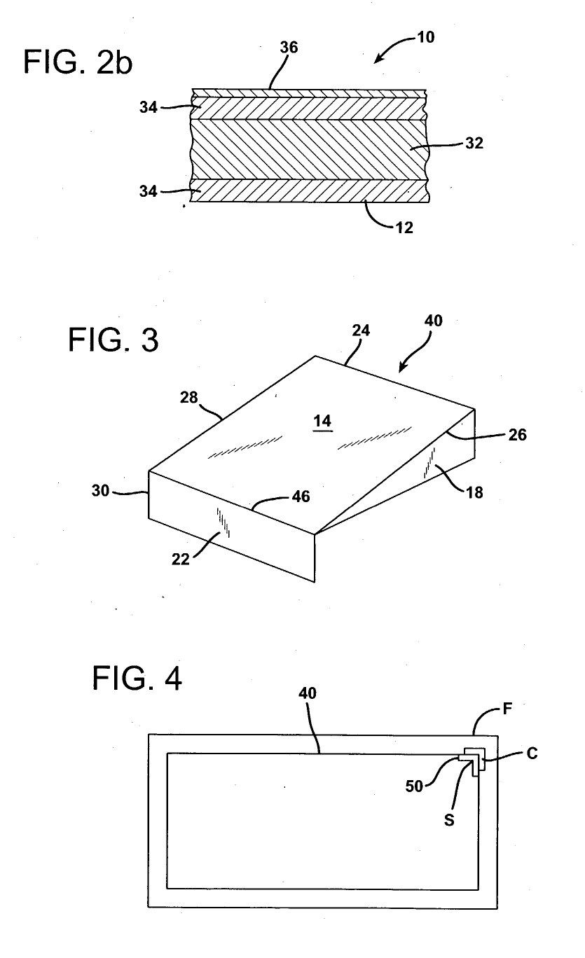

The insulating element 10 may be prepared as a two dimensional sheet 12 as illustrated in FIGS. 1 and 2a by means of substantially two dimensional molding tools such as platens. One of the platens includes ribs at appropriate positions in order to form the hinges 24, 26, 28, 40 between the panels 14,16, 18, 20, 22.

If desired during the molding process, the insulating element 10 may be provided with a relatively low density base zone 32 and a relatively high density surface zone 34. The relative thicknesses of the zones may be varied by controlling the temperatures of the platens, the pressure applied by the platens, the processing time and/or the melting points of the polymer based materials used. In the embodiment illustrated in FIG. 2a, the high density surface zone 34 is only provided along one face of the insulating element 10. It should be appreciated that such a high density surface zone 34 may be provided along the opposite face as well if desired. Of course, whether or not the high density surface zone 34 is provided, a high density zone will exist at the hinge 24, 26, 28, 30 where the polymer based blanket material is densified during the hinge forming process.

One possible alternative construction for the insulating element is illustrated in FIG. 2b. In this embodiment the polymer based blanket material includes a base zone 32 and two surface zones 34, one on each face of the polymer based blanket material. In addition, the insulating element 10 includes a facing layer 36. The facing layer 36 may be constructed from a material selected from a group consisting of polyester, rayon, metallic foil and any mixtures thereof. In the embodiment illustrated in FIG. 2a the facing layer 36 is provided along one face of the insulating element 10. It should, of course, be appreciated that the facing layer could also be provided on the opposite face of the insulating element 10 if desired.

FIG. 3 illustrates a final three dimensional consumer product 40 (e.g. an engine cover insulator) that is erected from the sheet like insulating element 10 illustrated in FIG. 1. The method of making the three dimensional product 40 illustrated in FIG. 3 will now be described in detail.

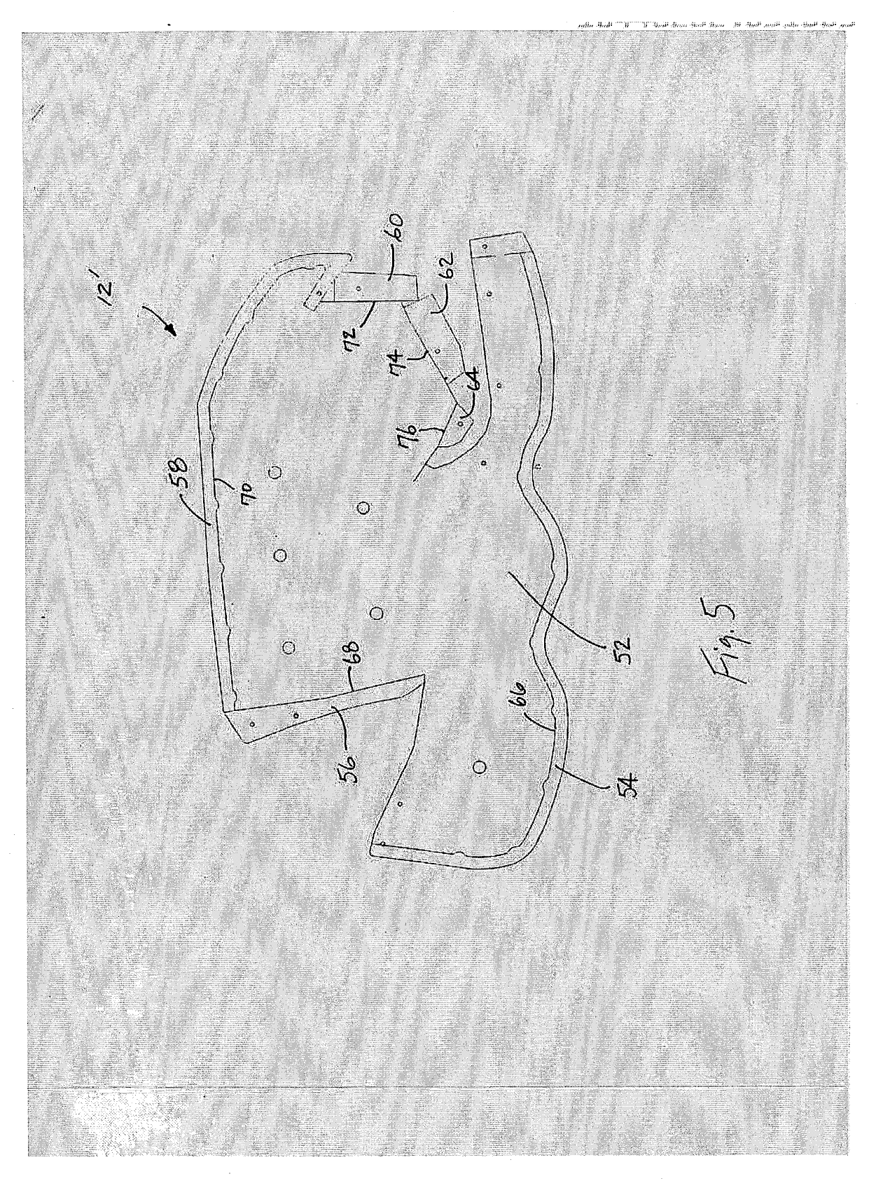

The method includes the cutting of a blank of polymer based blanket material to a desired two dimensional shape such as illustrated in the top plan view of FIG. 1. Next is the forming of the blank into a product sheet 12 including multiple panels 14, 16, 18, 20, 22 and hinges 24, 26, 28, 30 for interconnecting the panels in the manner described above. This is then followed by the folding of the multiple panels about the hinges in order to provide the three dimensional insulating product 40. The folding may be performed while fitting the insulating element to a consumer product such as a molded plastic or lightweight metal engine cover or to a fixture of desired size and shape. More specifically, as best illustrated in FIG. 4, panel 16 is folded along the hinge 24 relative to the first panel 14. Similarly, panels 18 and 20 are folded along the fold lines 26 and 28 relative to the first panel 14 while panel 22 is folded along the hinge 30 relative to the panel 20 as the insulating element 10 is fitted in the fixture F.

After the folding is completed, a seam is formed between the free edges 42 of the panels 16 and 18, the free edges 44 between the panels 16 and 20 and the free edges 46 between the panels 14 and 22. These seams may be sealed by use of an adhesive appropriate for use with the materials from which the insulating element 10 is constructed or by means of an appropriate tape 50.

If necessary or desirable, pins, clips or other fasteners C may be utilized to hold the seams S closed until the adhesive sets or taping is completed. When taping, the tape may be folded over the exposed edge of the panels at the ends of the seams in order to ensure good sealing. Following erection by the folding of the panel and the taping of the seams, a final, three dimensional product 40 (see FIG. 3) is made from the original two dimensional insulating element 10 (see FIG. 1).

It should be appreciated that FIGS. 1-4 illustrate a relatively simple product sheet 12 and three dimensional product 40. The invention does, however, allow for the construction of a far more complicated and multifaceted or paneled product. More specifically, as illustrated in FIG. 5, the sheet 12′ may comprise a main panel 52 and irregular edge or margin panels 54, 56, 58, 60, 62 and 64. The margin panels 54, 56, 58, 60, 62 and 64 are connected, respectively, to the main panel 52 by means of hinges 66, 68, 70, 72, 74 and 76. During folding, all the panels 52-64 remain flexible and, accordingly, they may be shaped in relief. Accordingly, the main panel 52 may, for example, be folded in a concave shape to provide a large cavity for receiving an engine block.

Numerous benefits result from employing the concepts of the present invention. First and foremost, significant capital savings is achieved since the manufacturer need only machine two dimensional molding tools rather than the traditional and more expensive three dimensional molding tools utilized to construct three dimensional parts in the prior art.

It should also be appreciated that shipping and handling benefits are also obtained. More specifically, the two dimensional insulating element in sheet-like form readily stacks without any wasted space and is thus easier to ship to a manufacturing or assembly plant. Further, the sheet-like material is easy to handle. Upon arrival it may be easily folded and erected for assembly purposes. In contrast, many three dimensional parts do not nest efficiently for shipping and are therefore bulky and require much larger volumes for shipping purposes.

The foregoing description of the preferred embodiment of the invention has been presented for purposes of illustration and description. It is not intended to be exhaustive or to limit the invention to the precise form disclosed. Obvious modifications or variations are possible in light of the above teachings. For example, while a five panel, four hinge insulating element is illustrated and described, it should be appreciated that the insulating element may include substantially any number of panels and hinges in substantially any shape or configuration.

Further, while the method is described first with reference to cutting a blank of polymer based blanket material and second with reference to forming that blank into a product sheet, it is not required to perform these steps in that order. In fact, the forming step could be completed before the cutting step and the claims should be interpreted to include this possibility.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. An insulating element, comprising:
a sheet of polymer based blanket material including multiple panels and at least one hinge for interconnecting said multiple panels.

2. The insulating element of claim 1 including a seam between said multiple panels and means for sealing said seam.

3. The insulating element of claim 1, including a seam between said multiple panels and an adhesive for sealing said seam.

4. The insulating element of claim 1, including a seam between said multiple panels and a tape for sealing said seam.

5. The insulating element of claim 4, including a portion of said tape folded over an edge of said sheet.

6. The insulating element of claim 1, wherein said polymer based blanket material is selected from a group of materials consisting of polyolefin, polyester, polypropylene, polyethylene, fiberglass, acrylic, natural fibers, nylon, rayon and blends thereof.

7. The insulating element of claim 1, wherein said polymer based blanket material is selected from a group consisting of (a) thermoplastic polyester staple fibers and thermoplastic bicomponent fibers, (b) glass staple fibers and thermoplastic bicomponent fibers and (c) mixtures thereof.

8. The insulating element of claim 1, further including a facing layer constructed from a material selected from a group consisting of polyester, rayon, metallic foil and any mixtures thereof.

9. The insulating element of claim 6, further including a facing layer constructed from a material selected from a group consisting of polyester, rayon, metallic foil and any mixtures thereof.

10. The insulating element of claim 7, further including a facing layer constructed from a material selected from a group consisting of polyester, rayon, metallic foil and any mixtures thereof.

11. The insulating element of claim 1, wherein said polymer based blanket material includes polyester staple fibers and polyester bicomponent fibers.

12. The insulating element of claim 11, wherein said polyester staple fibers and said polyester bicomponent fibers have diameters of between about 8.0 to about 30.0 microns and lengths between about 1.25 and about 8.0 cm.

13. The insulating element of claim 12, wherein said polymer based blanket material includes melt blown microfibers.

14. The insulating element of claim 1, wherein said insulating element is an engine cover insulator.

15. A method of making a three dimensional insulating product from a
two dimensional insulating element, comprising:
forming a two dimensional sheet of polymer based blanket material with multiple panels and at least one hinge for interconnecting said multiple panels; and
erecting said sheet of polymer based blanket materials into the three dimensional insulating product by folding said sheet about said at least one hinge.

16. The method of claim 15, including sealing a seam formed between said multiple panels following folding of said sheet.

17. The method of claim 15, including taping a seam formed between said multiple panels following folding of said sheet.

18. A method of making a three dimensional insulating product from a two dimensional insulating element, comprising:
cutting a blank of polymer based blanket material;
forming said blank into a product sheet including multiple panels and at least one hinge for interconnecting said panels; and
folding said multiple panels about said at least one hinge to provide the three dimensional insulating product.

19. The method of claim 18, further including using two dimensional tools in said forming.

20. A method of insulating a consumer product, comprising:
cutting a blank of polymer based blanket material;
forming said blank into a product sheet including multiple panels and at least one hinge for interconnecting said panels; and
folding said multiple panels about said at least one hinge to provide a three dimensional insulating product while fitting said insulating product to said consumer product.

21. The method of claim 20 further including sealing a seam formed between said multiple panels during folding.

22. The method of claim 20 further including taping a seam formed between said multiple panels during folding.

23. A method of insulating a consumer product, comprising:
cutting a blank of polymer based blanket material;
forming said blank into a product sheet including multiple panels and at least one hinge for interconnecting said panels; and
folding said multiple panels about said at least one hinge to provide a three dimensional insulating product while fitting said insulating product to a fixture corresponding to a desired size and shape.

24. The method of claim 23 further including sealing a seam formed between said multiple panels during folding.

25. The method of claim 20 further including taping a seam formed between said multiple panels during folding.

26. The method of claim 25 including clipping said product sheet to said fixture to hold said sheet in place prior to taping.
